(19) United States
(12) Patent Application Publication
(10) Pub. No.: US 2002/0003796 A1
(43) Pub. Date: Jan. 10, 2002

(54) Trafic control apparatus

(75) Inventors: Junichi Kugimiya, Fukuoka (JP); Takaharu Kajiwara, Fukuoka (JP); Michio Kusayanagi, Kawasaki (JP)

Correspondence Address: HELFGOTT & KARAS, P.C., Empire State Building, 60th Floor, New York, NY, 10118, US

(73) Assignee: FUJITSU LIMITED

(21) Appl. No.: 09/768,720

(22) Filed: Jan. 24, 2001

(30) Foreign Application Priority Data
Jul. 10, 2000 (JP) 2000-208069

(51) Int. Cl. H04L 12/56

(52) U.S. Cl. 370/389; 370/412; 370/419

(57) ABSTRACT

In a traffic control apparatus which controls data transmission rates of a plurality of channels, a transmission demand counter counts a transmission demand signal which a transmission demand generator generates at predetermined intervals set for each channel, a priority ranking determination portion determines a transmission priority ranking of each channel based on a value of the transmission demand counter by a round-robin method or other methods, and transmits a highest priority channel designation signal (cell transmission channel No.) which designates a transmission of a highest priority channel and a signal which decrements the transmission demand counter corresponding to the highest priority channel.

### BACKGROUND OF THE INVENTION

1. Field of the Invention

The present invention relates to a traffic control apparatus, and in particular to a traffic control apparatus which controls data transmission rates of a plurality of channels.

Generally, a plurality of channels (connections) are set in a single transmission line, virtual path, or the like, and are set with different transmission rates.

Accordingly, it is important to control a traffic of the transmission line (virtual path) so that a part of data may not be abandoned for the reason that the total of the transmission rates in the channels exceeds the transmission rate of the transmission line (virtual path).

2. Description of the Related Art

In a prior art traffic control apparatus, when an ATM cell is used as transfer data for example, a round-robin method has been generally and widely adopted in order to determine which ATM cell in a plurality of channels should be transmitted, by which a priority is preliminarily given to each channel and after the ATM cell of the highest priority channel is transmitted, its priority is lowered while raising the priorities of the remaining waiting channels to determine the channel to be transmitted next.

In this case, it is general to condition on each channel in order to guarantee the lowest transmission rate and to limit the maximum transmission rate.

The necessity of the maximum transmission rate limit will now be described. For example, it is assumed that an ATM cell in a certain channel is outputted from a transmission apparatus “A” at an output transmission rate “a”, and is inputted to a transmission apparatus “B” at an input transmission rate “b”.

If a transfer rate between the transmission apparatuses “A” and “B” is a<b, the ATM cell outputted from the transmission apparatus “A” can be transferred to the transmission apparatus “B” without abandoning any cell.

In some cases, the maximum transmission rate is limited by a contract of each user (channel). As an example of the traffic control apparatus which limits this maximum transmission rate, there is an apparatus that a transmission number of each channel is calculated per a certain transmission cell number, and the cells of the channels are scattered by the round-robin method for the transmission.

This apparatus requires a complicated calculator, especially accompanying a multiplication and a division for determining the cell transmission number of each channel so that the process becomes very complicated.

As a technology to realize the round-robin method, there are techniques such that; the highest priority path (channel and class No.) is made corresponding to an input of a priority encoder, which is rotated to change a priority ranking and to determine the next transmission channel; or memories for the number of channel are prepared, the number which each channel can select at each predetermined selection cycle is written in the memory corresponding to each channel, the contents of the memory corresponding to the channel selected within the selection cycle are decremented by “1”, the next channel whose memory contents are not “0” is retrieved, and the channel is determined to be the next transmission channel.

Generally, by the round-robin method, the intervals between the channels selected become long when the number of the entire channels is large, and the channels are often kept waiting. In the prior art traffic control apparatus, the transmission number is determined by the transmission rate limit including the number of channels which are kept waiting, so that in spite of an extra transmission timing it is not utilized.

Moreover, by a method that the transmission cell number is set per a certain transmission cell number (within a single detection cycle), the transmission cell number of all the valid class (channel) number is preliminarily determined. Therefore, it is impossible to dynamically change the condition of the maximum transmission rate limit within the detection cycle in the presence of many channels.

For example, the change of the transmission rate limit value of a single channel in many channels requires re-calculation of the transmission number of all the channels, resulting in complicated process.

In addition, the circuit which realizes the prior art round-robin method becomes too large for realization as the channel number to be supported becomes larger.

### SUMMARY OF THE INVENTION

It is accordingly an object of the present invention to provide a traffic control apparatus which controls data transmission rates of a plurality of channels and which effectively makes use of the transmission rate (bandwidth) of at least one of a transmission line and a virtual path without performing a complicated calculation process.

In addition, it is an object to provide a simple variable priority encoder.

In order to achieve the above-mentioned object, a traffic control apparatus according to the present invention of claim 1 comprises a transmission demand generator for generating a transmission demand signal at predetermined intervals set for each channel, a transmission demand counter for counting a generation number of the transmission demand signal for each channel, and a priority ranking determination portion for determining a transmission priority ranking of each channel based on a value of the transmission demand counter, and for transmitting a highest priority channel designation signal which designates a transmission of a predetermined unit data length of a highest priority channel and a signal which decrements the transmission demand counter corresponding to the highest priority channel.

Namely, the transmission demand generator generates the transmission demand signal at the predetermined intervals set for each channel. The transmission demand counter counts, per channel, the transmission demand signal for each channel.

The priority ranking determination portion determines the priority ranking of each channel based on the count value of the transmission demand counter of each channel, so that the highest priority channel designation signal for designating the transmission of the predetermined unit data of the highest priority channel among the channels is transmitted together with the signal for decrementing the transmission demand counter corresponding to the highest priority channel.

The counter corresponding to the highest priority transmission channel is decremented by the decrement signal.

A controlled apparatus which has received the highest priority channel designation signal transmits the predetermined unit data amount from the designated highest priority channel.

Thus, it becomes possible to transmit cells without performing a complicated calculation process.

In addition, the number of the unit data which have not been transmitted among the data amount to be transmitted at the predetermined intervals is stored in the counter corresponding to each channel. This number is stored until the data are transmitted. Therefore, the abandonment of the number of the unit data which have been kept waiting due to the priority of the channels does not occur. Also, the unit data are kept in a data buffer, so that the unit data are not abandoned as long as the data buffer does not overflow.

Although the intervals between the transmitted data fluctuate with respect to the predetermined intervals, the average transmission interval up to the time when e.g. the number of data not transmitted reaches “0” substantially assumes the predetermined interval. Namely, the average transmission interval assumes the transmission rate (bandwidth limit) set for each channel.

Also, in the present invention of claim 2 according to the present invention of claim 1, the transmission demand generator may generate the transmission demand signal as a transmission demand signal of fixed length data at intervals corresponding to a transmission rate of each channel, and the priority ranking determination portion may transmit the highest priority channel designation signal as a signal for designating a fixed length data transmission of the highest priority channel.

Namely, the transmission demand generator generates the transmission demand signal of the fixed length data (e.g. ATM cell) at the predetermined intervals corresponding to the transmission rate of each channel. The priority ranking determination portion designates the transmission of the fixed length data in the highest priority channel by the highest priority channel designation signal.

A controlled apparatus such as a queue portion outputs a single fixed length data of the designated highest priority channel.

As a result, the number of the fixed length data which have become a transmission stand-by state is to be held in the transmission demand counter corresponding to each channel. Based on this number, the priority ranking determination portion transmits the highest priority channel designation signal as a signal which designates the transmission of the fixed length data of the highest priority channel according to the predetermined priority ranking.

Thus, it becomes possible to perform the traffic control of the fixed length data.

Also, in the present invention of claim 3 according to the present invention of claim 2, the priority ranking determination portion may make a last highest priority channel a lowest priority from among channels whose transmission demand counter values are not “0”, and determine the highest priority channel by a round-robin method in which the highest priority channel is sequentially and recursively selected.

Thus, it becomes possible to scatter fixed length data (e.g. ATM cell) of a specified channel and to output the same.

Also, in the present invention of claim 4 according to the present invention of claim 3, when channel numbers are 1-N and a present highest priority channel number is M (1≦M≦N), the priority ranking determination portion may be composed of a first priority encoder which makes channels whose transmission demand counter values are not “0” valid channels, outputs a minimum channel number selected from the valid channels, or outputs an invalid signal in absence of the valid channels, a second priority encoder which masks channels whose numbers are under M, outputs a minimum channel number selected from the valid channels, and outputs an invalid signal in absence of the valid channels, a determination portion which outputs the minimum channel number outputted by the second priority encoder as a highest priority channel designation signal regardless of an output of the first priority encoder, outputs the minimum channel number outputted by the first priority encoder as a highest priority channel designation signal when the second priority encoder outputs the invalid signal, or outputs an invalid signal when both of the first and the second priority encoders output the invalid signals, and an adder which makes the highest priority channel number +1 a next highest priority channel number M.

Namely, assuming that the channel Nos. “1”-“N” are respectively allocated to “N” number of channels and the present highest priority channel No. is “M”, the first priority encoder outputs the minimum channel No. from among the valid channels whose transmission demand counter values are not “0” in all of the channels, and outputs the invalid signal in the absence of the valid channels, that is, when the values of all the transmission demand counters are “0”.

The second priority encoder masks the channels whose Nos. are under “M” and outputs the minimum channel No. in the valid channels whose Nos. are equal to or more than “M”, and outputs the invalid signal in the absence of the valid channel, that is, when the values of all the transmission demand counters in the channels whose Nos. are equal to or more than “M” are “0”.

The determination portion outputs the minimum channel No. outputted by the second priority encoder as the highest priority channel regardless of the output of the first priority encoder, outputs the minimum channel No. outputted by the first priority encoder as the highest priority channel No. only when the second priority encoder outputs the invalid signal, and outputs the invalid signal when both of the first and the second priority encoders output the invalid signals.

The adder outputs the transmission channel No. +1 as a next highest priority channel No. “M”.

Thus, the determination portion specifies the highest priority channel No. from among the channels whose Nos. are more than “M” and are not masked. In the absence of the valid channel, the determination portion returns to channel No. 1 to specify the highest priority channel in the remaining masked Nos. “1”-“(M-1)”.

As a result, it becomes possible for the priority ranking determination portion to determine the highest priority channel by the round-robin method and to provide a simple variable priority encoder.

Also, in the present invention of claim 5 according to the present invention of claim 4, the priority ranking determination portion may further include a single priority encoder composed of the first and the second priority encoders, a timing generator which controls the priority encoder to perform operations of the first and the second priority encoders by time sharing, and a storage portion which stores an output result of the priority encoder to be provided to the determination portion by a timing designated by the timing generator.

Also by this priority ranking determination portion, it becomes possible to determine the highest priority channel by the above-mentioned round-robin method.

It is to be noted that when the data of each channel have variable lengths in the present invention of claim 1, the transmission demand generator generates the transmission demand signal as a transmission demand signal of a unit data length at the predetermined intervals corresponding to the transmission rate of each channel.

The priority ranking determination portion, based on a length of variable length data of each channel and the value of the transmission demand counter, that is, from among the channels whose lengths of the variable length data are equal to or less than the data length (unit data length×counter value) which can be transmitted indicated by the value of the transmission demand counter, determines the highest priority channel, outputs the highest priority channel designation signal which designates a variable length data transmission of the highest priority channel, and subtracts a numerical value corresponding to the length of the variable length data transmitted from the transmission demand counter corresponding to the highest priority channel.

Thus, it becomes possible to apply the traffic control apparatus according to the present invention to the case where the transmission data are variable length data.

Also, in the present invention of claim 1, the priority ranking determination portion can perform weighting to the value of the transmission demand counter, and determine the transmission priority ranking of each channel. Thus, the priority ranking determination portion can designate a preferential transmission of data of a specified channel.

Furthermore, in the invention of claim 1, predetermined intervals are set so that a total of transmission rates (bandwidth) corresponding to the predetermined intervals set for each channel does not exceed a maximum transmission rate permitted to e.g. a virtual path (or transmission line) including the channel. Thus, it becomes possible to prevent the data of each channel transmitted within the virtual path from being abandoned. Also, if such a setting is performed to a plurality of virtual paths, the maximum transmission rate of each virtual path can be prescribed.

### BRIEF DESCRIPTION OF THE DRAWINGS

FIG. 1 is a block diagram showing an embodiment of a traffic control apparatus according to the present invention;

FIG. 2 is a block diagram showing an arrangement (1) of a variable priority encoder in a traffic control apparatus according to the present invention;

FIGS. 3A-3H are diagrams showing an algorithm of a variable priority encoder in a traffic control apparatus according to the present invention;

FIG. 4 is an output truth value table of a determination portion of a variable priority encoder in a traffic control apparatus according to the present invention;

FIG. 5 is a block diagram showing an arrangement (2) of a variable priority encoder in a traffic control apparatus according to the present invention;

FIG. 6 is a block diagram showing an arrangement of a traffic control apparatus according to the present invention and a queue portion controlled by this traffic control apparatus;

FIGS. 7A-7F are time charts showing an operation example (1) of a cell transmission of a traffic control apparatus according to the present invention; and

FIGS. 8A-8G are time charts showing an operation example (2) of a cell transmission of a traffic control apparatus according to the present invention.

Throughout the figures, like reference numerals indicate like or corresponding components.

### DESCRIPTION OF THE EMBODIMENTS

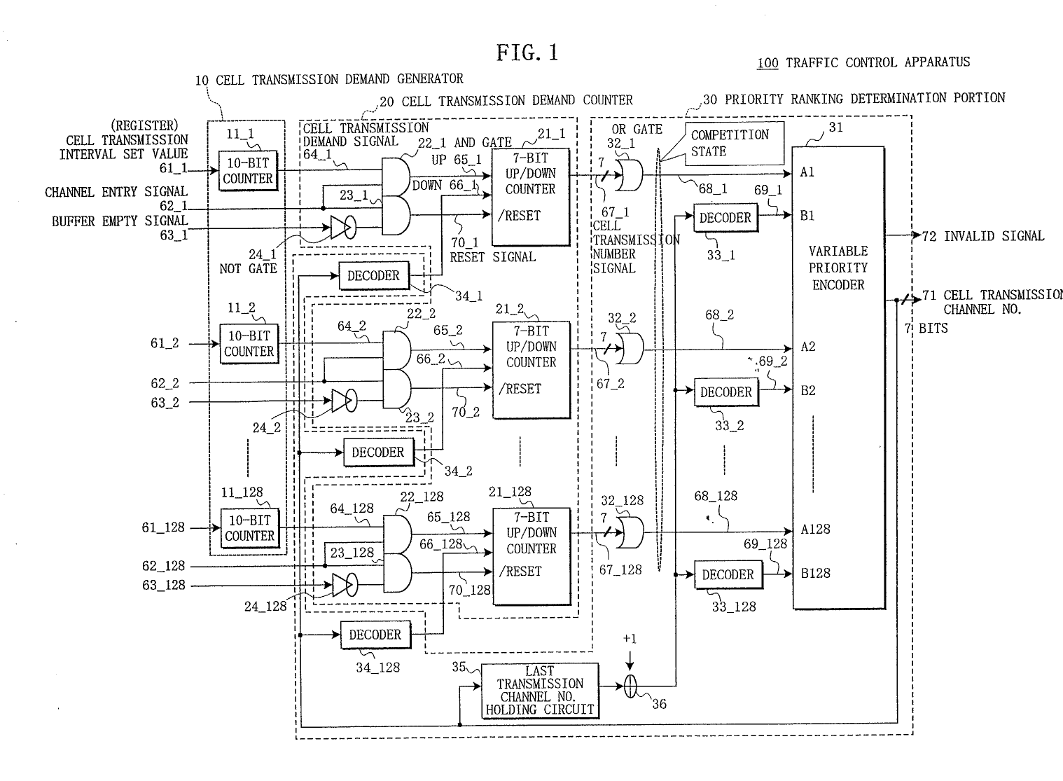

FIG. 1 shows an embodiment of a traffic control apparatus 100 according to the present invention. This traffic control apparatus 100 controls a queue portion (not shown) composed of e. g. a data buffer which queues transmitting data and a transmitter (selector) which selects the queued data and transmits the same, and transfers an ATM cell to a transmission line (or virtual path) at a transmission rate set for each channel.

Also, this embodiment shows a traffic control example of an ATM cell which is fixed length data as transmitting data of each channel (128 channels).

The traffic control apparatus 100 is composed of a cell transmission demand generator 10 which outputs cell transmission demand signals 64_1-64_128 (hereinafter, sometimes generally referred to as reference numeral 64) for each channel, a cell transmission demand counter 20 which counts the cell transmission demand signal 64 for each channel, subtracts the number of transmitted cells, and holds (counts) the number of cells which have not been transmitted yet, and a priority ranking determination portion 30 which determines a priority of a cell transmission of each channel based on the value of the counter 20.

The cell transmission demand generator 10 inputs cell transmission interval set values 61_1-61_128 (hereinafter, sometimes generally referred to as reference numeral 61) set in registers (not shown) for each channel, and is composed of 10-bit counters 11_111_128 which generate the cell transmission demand signal 64 at each interval designated by the set value 61.

The cell transmission demand counter 20 includes AND gates 22_1-22_128 which output a logical multiplication of the cell transmission demand signal 64 for each channel and channel entry signals 62_1-62_128 (hereinafter, sometimes generally referred to as reference numeral 62) corresponding to each channel respectively as increment signals (UP) 65_1-65_128 (hereinafter, sometimes generally referred to as reference numeral 65).

Also, the cell transmission demand counter 20 includes AND gates 23_1-23_128 which output the logical multiplication of the channel entry signal 62 for each channel with buffer empty signals 63_1-63_128 (hereinafter, generally referred to as reference numeral 63) corresponding to each channel respectively as reset signals 70_170_128 (hereinafter, sometimes generally referred to as reference numeral 70).

Furthermore, the cell transmission demand counter 20 includes up/down counters 21_1-21_128 (hereinafter sometimes generally referred to as reference numeral 21) which output the number of ATM cells which have not been transmitted in the form of 7-bit cell transmission number signals 67_1-67_128 (hereinafter, sometimes generally referred to as reference numeral 67) by the increment signal 65 for each channel and decrement signals (DOWN) 66_1-66_128 (hereinafter, sometimes generally referred to as reference numeral 66) of each channel from the priority ranking determination portion 30, and is reset to output “0” when a reset signal 70 (negative logic) indicates “reset”.

The priority ranking determination portion 30 includes OR gates 32_1-32_128 (hereinafter, sometimes generally referred to as reference numeral 32) which output the logical sum of the 7-bit cell transmission number signal 67 for each channel as entry signals 68_1-68_128 (hereinafter, sometimes generally referred to as reference numeral 68), and a variable priority encoder 31 which inputs the entry signal 68 and priority signals 69_1-69_128 from decoders 33_1-33_128 described later, and outputs a cell transmission channel No. 71 which is a signal for designating a 7-bit highest priority channel and an invalid signal 72.

In addition, the priority ranking determination portion 30 includes decoders 34_1-34_128 (hereinafter, sometimes generally referred to as reference numeral 34) which respectively input the cell transmission channel No. 71, the last transmission channel No. holding circuit 35, an addition circuit 36 which adds “1” to the output of the holding circuit 35, and the decoders 33_1-33_128 which input the result of the addition.

It is to be noted that when channel No. “1” is inputted to the decoder 34_1, the decoder 34_1 provides the counter 21_1 corresponding to the channel No. “1” with the decrement signal 66_1 which indicates the decrement by “1”.

In operation, the 10-bit counter 11 outputs the cell transmission demand signal 64 at set intervals (transmission rate) by an ideal timing for a single cell transmission.

When the channel entry signal 62 is “1”, the channel is entered, and the corresponding counter 21 respectively counts up and counts down the signals 65 and 66, thereby holding the number of cells which have not been transmitted yet.

In addition, when the channel entry signal 62 is “0”, the counter 21 is reset by the reset signal 70 to hold “0”. Furthermore, when no data is in the buffer of the above-mentioned queue portion, that is, when the buffer empty signal 63 is “0”, the counter 21 is reset because the number of cells which have not been transmitted yet is “0”.

In the priority ranking determination portion 30, the OR gate 32 decides whether or not the value of the counter 21 is “0”, the decoder 34 provides the counter 21 corresponding to the channel which has transmitted the cell with the decrement signal 66, the holding circuit 35 and the addition circuit 36 provide the decoder 33 with the next channel No. (highest priority channel No.) of the transmission channel No, and the decoder 33 provides the variable priority encoder 31 with the priority signal 60-“1” corresponding to the transmission channel No.

The encoder 31, based on the signals 68 and 69, determines and outputs by the round-robin method either the cell transmission channel No. 71 to transmit the cells or the invalid signal 72 indicating that there is no cell to be transmitted.

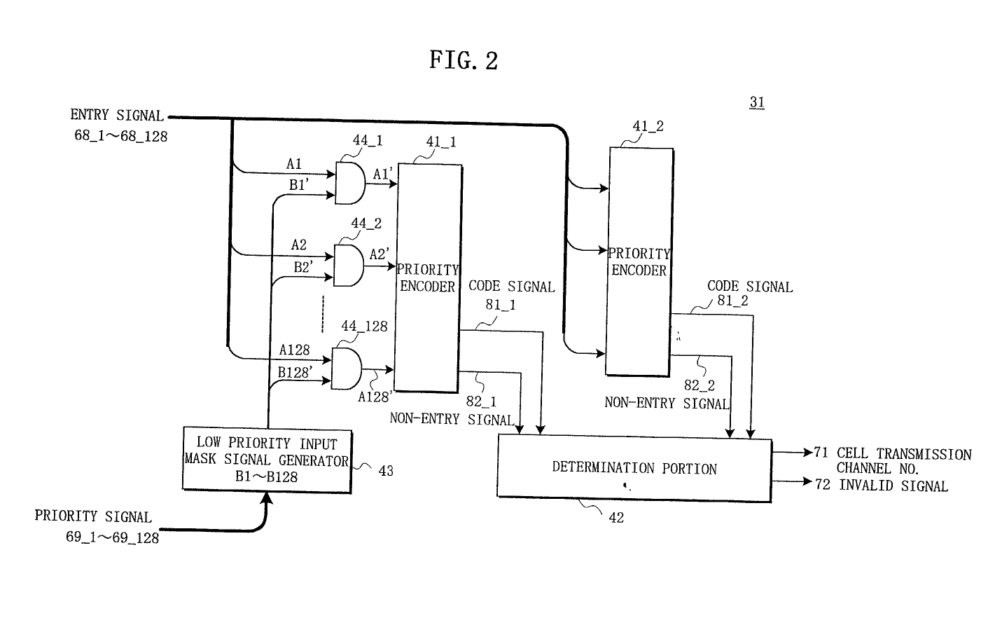

FIG. 2 shows an embodiment of the variable priority encoder 31 shown in FIG. 1. This encoder 31 determines the priority ranking of the channels to transmit the cells by the round-robin method as mentioned above.

The encoder 31 is composed of a low priority input mask signal generator 43 for inputting the priority signals 69_1-69_128 and for outputting mask signals B1′-B128′, AND gates 44_1-44_128 for respectively outputting logical multiplication A1′-A128′ of the mask signals B1′-B128′ and the entry signals 68_1-68_128 corresponding to each channel, a priority encoder 41_1 for inputting the logical multiplication A1′-A128′ and for outputting a code signal 81_1 and a non-entry signal 82_1, a priority encoder 41_2 for inputting only the entry signals 68_1-68_128 and for outputting a code signal 81_2 and a non-entry signal 82_2, and a determination portion 42 for inputting the code signals 81_1, 81_2 as well as the non-entry signals 82_1, 82_2, and for outputting the cell transmission channel No. 71 and the invalid signal 72.

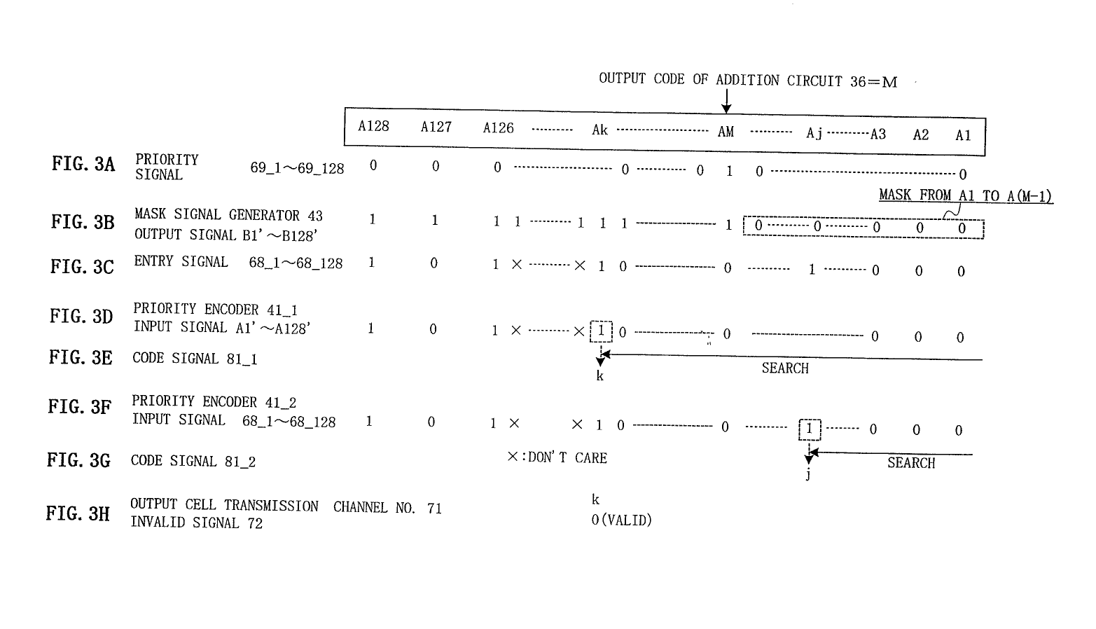

FIGS. 3A-3H show an operation algorithm of the variable priority encoder 31 in FIG. 2.

FIG. 3A shows priority signals 69_1-69_128 inputted to the mask signal generator 43. In this example, since the highest priority channel No. is “M”, the priority signal 69_M is “1”, and the other priority signals 69 are “0”.

FIG. 3B shows mask signals B1′-B128′ of the mask signal generator 43. Since the priority signal 69_M is “1”, the mask signals BM′-B128′ are “1” while the remaining mask signals B1′-B(M-1)′ are “0”

FIG. 3C shows entry signals 68_1-68_128. In this example, the entry signals 68_j, 68_k, 68_126, and 68_128 are “1”, and the entry signals 68_1-68_j-1, 68_j+1-68_k-1, and 68_127 are “0”. The remaining entry signals 68_k+1-68_125 are “don't-care”, and may be either the value of “1” or “0”.

FIG. 3D shows output signals of the AND gates 44_1-44_128, that is, the input signals A1′-A128′ of the priority encoder 41_1. These input signals A1′-A128′ indicate the logical multiplication of the signal of FIG. 3B and the signal of FIG. 3C for each channel, and a signal Aj′ is masked to be “0”.

FIG. 3E shows a code signal 81_1 which is the output signal of the priority encoder 41_1. The priority encoder 41_1 searches the input signals whose values are “1” in the order of A1′, A2′, . . . to detect an input signal Ak′=“1”. Then, the priority encoder 41_1 outputs the value of “k” as the code signal 81_1, and outputs “0” indicating “not invalid” to the non-entry signal 82_1. It is to be noted that when all of the input signals A1-A128 are “0”, the priority encoder 41_1 outputs “1” indicating “invalid” to the non-entry signal 82_1.

FIG. 3F shows input signals of the priority encoder 41_2, which are the same as the entry signals 68_1-68_128 in FIG. 3C.

FIG. 3G shows a code signal 81_2 which is the output signal of the priority encoder 41_2. The priority encoder 41_2 searches the input signals whose values are “1”, in the same way as the priority encoder 41_1, to detect the input signal Aj=“1”. Then, the priority encoder 41_2 outputs the value of “j” as the code signal 81_2, and outputs “0” to the non-entry signal 82_2. It is to be noted that when all of the input signals A1-A128 are “0”, the priority encoder 41_2 outputs the nonentry signal 82_2=“1” in the same way as the priority encoder 41_1.

In case of FIG. 3H, the cell transmission channel No. 71=“k” and the invalid signal 72=“valid”=“0” are outputted by the determination portion 42.

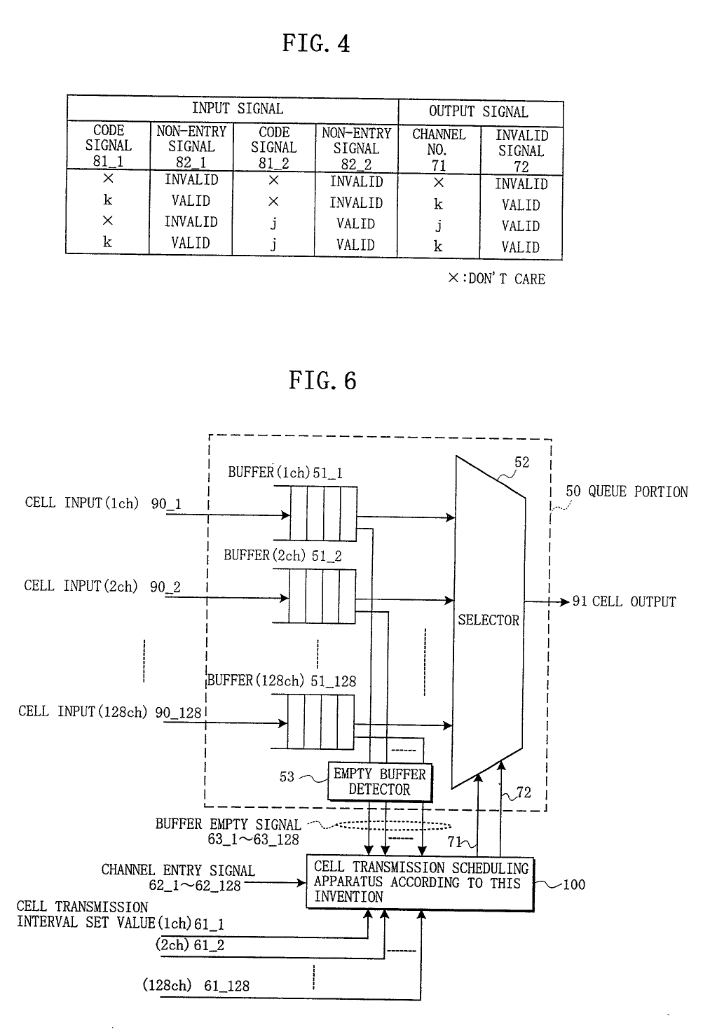

FIG. 4 shows a truth value table of the input/output signal at the determination portion 42 shown in FIG. 2.

The determination portion 42 outputs the code signal 81_1 (=“k”) as the cell transmission channel No. 71 when the non-entry signal 82_1 is “valid”=“0” (i. e. not “invalid”), and outputs the code signal 81_2 (=“j”) when the non-entry signal 82_1 is “invalid”=“I” and the nonentry signal 82_2 is “valid”=“0”

The determination portion 42 outputs “1” indicating “invalid” to the invalid signal 72 only when both non-entry signals 82_1 and 82_2 are invalid.

As a result, the variable priority encoder 31 determines the highest priority channel by the round-robin method with channels being rotated in the order of channel 1, channel 2, . . . , channel 128, channel 1,. . . At this time, the variable priority encoder 31 determines the highest priority channel by the method of selecting only the valid channels.

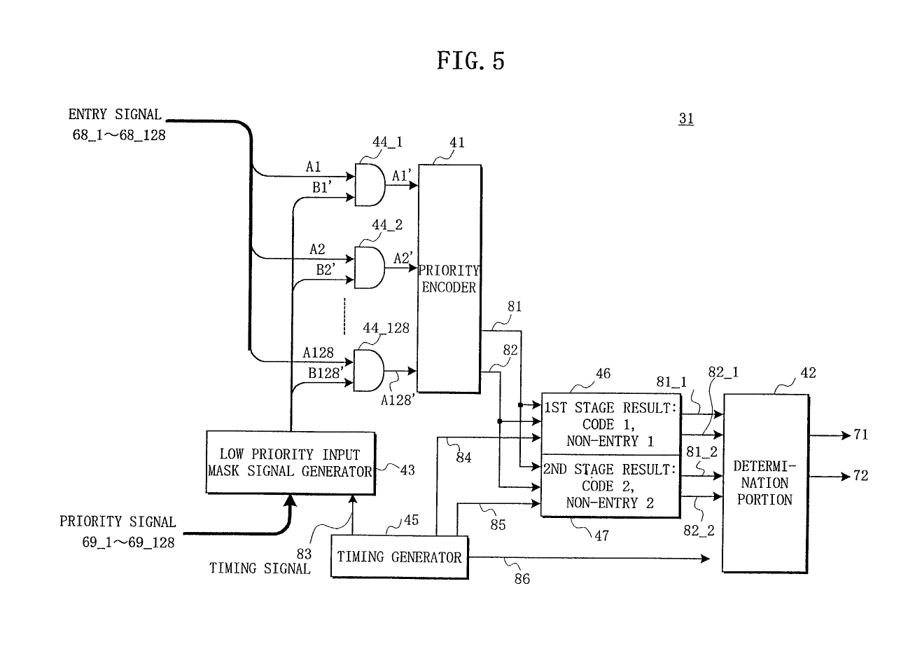

FIG. 5 shows a modification of the variable priority encoder 31 shown in FIG. 2. In this example, a priority encoder 41 is set to function as the priority encoders 41_1 and 41_2 of FIG. 2 by time sharing.

The variable priority encoder 31 is composed of the mask signal generator 43, the AND gates 44_1-44_128, and the priority encoder 41 connected in the same way as FIG. 2, the determination portion 42 having the same function as FIG. 2, storage portions 46 and 47 for storing the code signal 81 and the non-entry signal 82 from the priority encoder 41, and a timing generator 45 for respectively providing the mask signal generator 43, the storage portions 46 and 47, and the determination portion 42 with timing signals 83-86.

An operation example when the priority signals 69_1-69_128 (that is, the highest priority channel No. is “M”) and the entry signals 68_1-68_128, respectively same as FIGS. 3A and 3C, are inputted will now be described with the operation being divided into timings T1-T3 (not shown).

Timing T1: The mask signal generator 43 outputs the mask signals B1′-B128′ of FIG. 3B, and the priority encoder 41 outputs the code “k” as the code signal 81 in the same way as FIG. 3E, and the nonentry signal 82 indicating “valid”. The storage portion 46 stores the code “k” and the non-entry signal to be outputted as the code signal 81_1 and the non-entry signal 82_1.

Timing T2: The mask signal generator 43 outputs all of the mask signals B1′-B128′=“1”, and the priority encoder 41 outputs the code “j”, as the code signal 81 in the same way as FIG. 3G, and the non-entry signal 82 indicating “valid”. The storage portion 47 stores the code “j”, and the non-entry signal 82 to be outputted as the code signal 81_2 and the non-entry signal 82_2.

Timing T3: The determination portion 42 calculates, based on the output truth value table shown in FIG. 4, the cell transmission channel No. 71 and the invalid signal 72 from the code signals 81_1 and 81_2, and the non-entry signals 82_1 and 82_2 to be respectively outputted.

As a result, the variable priority encoder 31 can determine the highest priority channel by sequentially selecting only the valid channels with the round-robin method.

FIG. 6 shows an arrangement of a queue portion 50 controlled by the traffic control apparatus (cell transmission scheduling apparatus) 100 according to the above-mentioned present invention. The queue portion 50 is composed of buffers 51_1-51_128 (hereinafter, generally referred to as reference numeral 51), a selector 52, and an empty buffer detector 53.

The buffer 51 inputs the cells respectively from cell input terminals 90_1-90_128 corresponding to the channels ch1-ch128 to be stored. The selector 52 receives the cell transmission channel No. 71 and the invalid signal 72 from the cell transmission scheduling apparatus 100, and takes out a single cell from the buffer 51 corresponding to the cell transmission channel No. 71 to be outputted to a cell output terminal 91 when the invalid signal 72 does not indicate “invalid”.

The empty buffer detector 53 detects whether or not the buffer 51 is empty to provide the scheduling apparatus 100 with the buffer empty signal 63 (see FIG. 1).

In the traffic control apparatus 100, the counter 21 of the channel corresponding to the buffer empty signal 63 indicating “empty” is reset. Thus, the channel is not selected by the variable priority encoder 31.

Also, the selector 52 does not transmit the cell or transmits the empty cell when the invalid signal 72 indicates “invalid”.

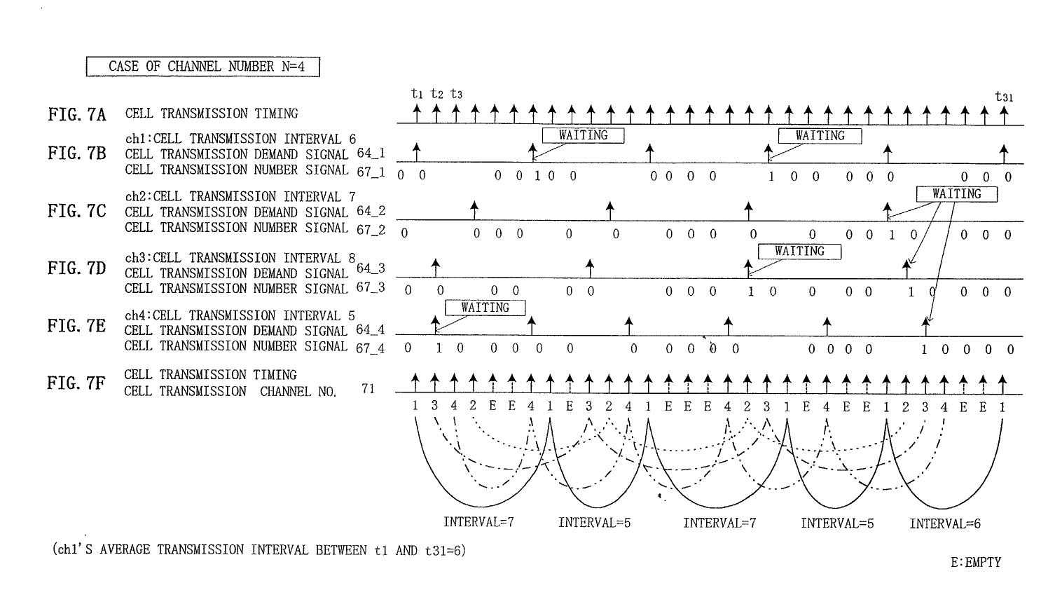

FIGS. 7A-7F show an operation timing of the traffic control apparatus 100 and a timing example of outputting the cells from the queue portion 50. In this example, the channel entry signals 62_1-62_4 are set to “1”, the other channel entry signals 62 are set to “0” (see FIG. 1), and the channel number “N” is 4. The operation will now be described referring to FIGS. 1 and 6.

FIG. 7A shows timings t1, t2, t3, . . . (that is, transmission rate (bandwidth) timing of transmission line) when the cells can be transmitted from the selector 52. FIGS. 7B-7E show cell transmission demand signals 64 and cell transmission number signals 67 of the channels ch1ch4 (see FIG. 1), and the numbers of the cell transmission number signals 67 at an initial state are “0”. As shown in FIGS. 7B-7E, “6”, “7”, “8”, and “5” are respectively set to the cell transmission interval set values 61 (transmission rate) of the channels ch1-ch4 (see FIGS. 1 and 6).

Namely, the transmission rates of the channels ch1-ch4 are respectively ⅙, 1/7, ⅛, and ⅕ of the maximum transmission rate, so that the totaled transmission rate becomes 533/840 of the maximum transmission rate.

FIG. 7F shows a cell transmission channel No. 71 which is the highest priority channel No. and a timing when the selector 52 transmits the cells according to the highest priority channel No. (see FIG. 6).

In operation, the cell transmission demand signal 64_1 of the channel ch1 is outputted at the timing t1 (see FIG. 7A), and the counter 21_1 (see FIG. 1) counts up, so that the cell transmission number signal 67_1 becomes “1”. At the timing t1, the cell stored in the buffer 51_1 (see FIG. 6) of the channel ch1 is immediately outputted from the selector 52, so that the cell transmission number signal 67_1 becomes “0”. It is to be noted that the case where the cell transmission number signal 67 becomes “1” at a moment is omitted, and will be omitted in the same way, hereinafter.

The cell transmission demand signals 64 of the channels ch3 and ch4 are outputted at the timing t2.

The counters 21_3 and 21_4 are incremented by “1”, and the cell transmission number signals 67_3 and 67_4 become “1”. The cell of the channel ch3 is immediately outputted from the selector 52, so that the cell transmission number signal 67 becomes “0”. On the other hand, the cell of the channel ch4 is not outputted, so that the cell transmission number signal 67 maintains the value “1” to have “waiting” state.

The cell stored in the buffer 51_2 (not shown in FIG. 6) of the channel ch4 is outputted at the timing t3, and the cell transmission number signal 67 becomes “0”, so that the “waiting” state is canceled. Hereafter, the cell in each channel will be transmitted from the selector 52 in the same way.

FIG. 7F shows a timing when the cell is transmitted from the selector 52, the channel No. of the transmitting cell, and the interval of transmitting the cell in the same channel.

For example, the intervals between the cell transmissions of the channel ch1 are “7”, “5”, “7”, “5”, and “6”. Although the interval is “5” in some cases which is shorter (that is, transmission rate is fast) than the set cell transmission interval=“6”, the average transmission interval (average transmission rate) between the timings t1-t31 is equal to the set transmission interval set value=“6”.

It is to be noted that the reason why the average interval (average transmission rate) of the first three intervals “7”, “5”, and “7” between the cell transmissions of the channel ch1 are larger than the set transmission interval set value=“6” is that the cell transmission number signal 67_1 at this time is “1”, that is, a single cell is not transmitted, and is in the “waiting” state.

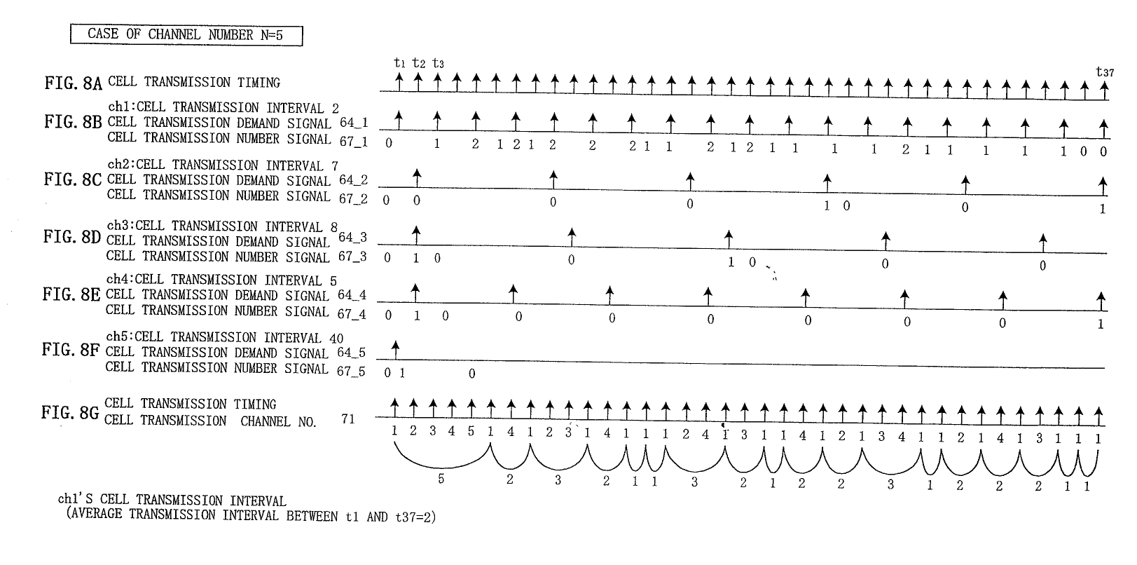

FIGS. 8A-8G show an operation timing of the traffic control apparatus 100 and an example of a timing when the cells are outputted from the queue portion 50 in the same way as FIGS. 7A-7F. In this example, the channel entry signals 62_1-62_5 are set to “1”, and the other channel entry signals 62 are set to “0”, and the channel number “N” is 5.

While FIGS. 8A-8E, and 8G are corresponding to FIGS. 7A-7E, and 7F, the transmission interval of the channel ch1 in FIG. 8B is changed to “2”, and the timing of the cell transmission demand signal 64 in FIG. 8C is shifted forward by “2 timing components” from the timing of FIG. 7C.

FIG. 8F shows a cell transmission demand signal 64 and a cell transmission number signal 67 of the channel ch5. The cell transmission interval set value 61 of the channel ch5 is set to “40”.

The transmission rates of the channels ch1-ch5 are respectively ½, 1/7, ⅛, ⅕, and 1/40 of the maximum transmission rate of the transmission line (or virtual path). The totaled transmission rate of these rates is “278/280” of the maximum transmission rate, and is set to utilize almost the maximum transmission rate (whole bandwidth) of the transmission line by the whole channels ch1-ch5. *According to the cell transmission channel No. 71 of FIG. 8G determined in the same way as FIG. 7, the transmission intervals of e. g. the channel ch1 become “5”, “2”, “3”, . . . “2”, “1”, and “1”, and the average interval between the timings t1 and t31 is “2”, so that the cell abandonment does not occur.

Moreover, in some cases the cell transmission interval of the channel ch1 becomes “1” shorter than the set cell transmission interval=“2”. This is the case where the cell of the channel ch1 to be transmitted is transmitted at an “empty” timing when generated cells are not transmitted or an empty cell is transmitted in FIG. 7F.

Namely, this indicates that the waiting cell which is originally to be outputted is positively outputted if there is an extra bandwidth. Thus, it is possible to effectively make use of the transmission line (or virtual path, or the like) by the traffic control apparatus according to the present invention.

It is to be noted that while the priority ranking of the cell transmission is determined by the round-robin method in the above-mentioned embodiment, it is also possible to adopt a method for setting a fixed priority ranking for the channel.

In the above-mentioned embodiment, the traffic control apparatus 100 which performs the transmission scheduling of the ATM cells has been described. However, not only the cells but also other fixed length data may be adopted.

Also, for example, if the total of the transmission rates (bandwidth) corresponding to the predetermined intervals set for each of a plurality of channels included in a single virtual path (or transmission line) is set so that the total may not exceed the maximum transmission rate permitted to the virtual path, it is possible to realize the transmission without the data abandonment within the permitted maximum transmission rate of the virtual path. If this transmission is performed in a plurality of virtual paths, it becomes possible to realize a fixed transmission rate service of each virtual path.

Furthermore, the traffic control apparatus according to the present invention can be applied to the case where the data of each channel have variable lengths.

The transmission demand generator 10 generates the transmission demand signal 64 of the unit data length at predetermined intervals corresponding to the transmission rate of each channel. The transmission demand counter 20 counts the signal 64.

The priority ranking determination portion 30, based on the variable length data of each channel and the value of the transmission demand counter 20, namely, from among the channels whose variable length data lengths are equal to or less than the data length (unit data length×counter value) which can be transmitted indicated by the value of the transmission demand counter, determines the highest priority channel, transmits the variable length data of the highest priority channel, and subtracts the numerical value corresponding to the variable length data transmitted from the transmission demand counter corresponding to the highest priority channel.

Thus, the traffic control apparatus according to the present invention can be applied to the case where the transmission data are the variable length data.

It is to be noted that when the length of the transmitted variable length data is shorter than the data length (unit data length×counter value) which can be transmitted, such a method is adopted that the difference is stored, and the difference is added to the next data length which can be transmitted, so that the traffic control with less waste in the bandwidth can be performed.

As described above, a traffic control apparatus according to the present invention is arranged such that a transmission demand counter counts a transmission demand signal which a transmission demand generator generates at predetermined intervals set for each channel, a priority ranking determination portion determines a transmission priority ranking of each channel based on a value of the transmission demand counter by a round-robin method or other methods, and transmits a highest priority channel designation signal which designates a transmission of a highest priority channel and a signal which decrements the transmission demand counter corresponding to the highest priority channel. Therefore, it becomes possible to effectively make use of a transmission rate (bandwidth) of a transmission line or a virtual path without a complicated calculation process.

Also, the transmission demand signal is generated as a transmission demand signal of fixed length data or unit data, and the priority ranking determination portion transmits the highest priority channel designation signal as a signal for designating fixed length data or variable length data of the highest priority channel. Therefore, it becomes possible to apply the traffic control apparatus according to the present invention to both of the fixed length data and the variable length data.

Also, the traffic control apparatus according to the present invention is arranged such that when a present highest priority channel No. is “M”, the priority ranking determination portion masks channels whose Nos. are under “M”, outputs a minimum channel No. selected from the valid channels as the highest priority channel designation signal, and outputs the minimum channel No. selected from the valid channels whose Nos. are under “M” as the highest priority channel designation signal in absence of the valid channels, so that the highest priority channel No. +1 is made a next highest priority channel No. “M”. Therefore, it becomes possible to provide a simple variable priority encoder (round-robin method).

Furthermore, the traffic control apparatus according to the present invention is arranged such that intervals of the transmission demand signals for each channel are set so that a total of transmission rates corresponding to the predetermined intervals set for each channel may not exceed a maximum transmission rate which can be transmitted on a transmission line or a virtual path including the channel. Therefore, it becomes possible to prevent data of each channel transmitted within the transmission line or the virtual path from being abandoned, and to effectively make use of the transmission rate (bandwidth).

Also, if such a setting is performed to a plurality of virtual paths, the maximum transmission rate of each virtual path can be prescribed.

What we claim is:

1. A traffic control apparatus comprising:
a transmission demand generator for generating a transmission demand signal at predetermined intervals set for each channel,
a transmission demand counter for counting a generation number of the transmission demand signal for each channel, and
a priority ranking determination portion for determining a transmission priority ranking of each channel based on a value of the transmission demand counter, and for transmitting a highest priority channel designation signal which designates a transmission of a predetermined unit data length of a highest priority channel and a signal which decrements the transmission demand counter corresponding to the highest priority channel.

2. The traffic control apparatus as claimed in claim 1 wherein the transmission demand generator generates the transmission demand signal as a transmission demand signal of fixed length data at intervals corresponding to a transmission rate of each channel, and the priority ranking determination portion transmits the highest priority channel designation signal as a signal for designating a fixed length data transmission of the highest priority channel.

3. The traffic control apparatus as claimed in claim 2 wherein the priority ranking determination portion makes a last highest priority channel a lowest priority from among channels whose transmission demand counter values are not “0”, and determines the highest priority channel by a round-robin method in which the highest priority channel is sequentially and recursively selected.

4. The traffic control apparatus as claimed in claim 3 wherein when channel numbers are 1-N and a present highest priority channel number is M (1≦M≦N), the priority ranking determination portion is composed of a first priority encoder which makes channels whose transmission demand counter values are not “0” valid channels, outputs a minimum channel number selected from the valid channels, or outputs an invalid signal in absence of the valid channels, a second priority encoder which masks channels whose numbers are under M, outputs a minimum channel number selected from the valid channels, and outputs an invalid signal in absence of the valid channels, a determination portion which outputs the minimum channel number outputted by the second priority encoder as a highest priority channel designation signal regardless of an output of the first priority encoder, outputs the minimum channel number outputted by the first priority encoder as a highest priority channel designation signal when the second priority encoder outputs the invalid signal, or outputs an invalid signal when both of the first and the second priority encoders output the invalid signals, and an adder which makes the highest priority channel number +1 a next highest priority channel number M.

5. The traffic control apparatus as claimed in claim 4 wherein the priority ranking determination portion further includes a single priority encoder composed of the first and the second priority encoders, a timing generator which controls the priority encoder to perform operations of the first and the second priority encoders by time sharing, and a storage portion which stores an output result of the priority encoder to be provided to the determination portion by a timing designated by the timing generator.

6. The traffic control apparatus as claimed in claim 1 wherein data of each channel comprise variable length data, the transmission demand generator generates the transmission demand signal as a transmission demand signal of a unit data length at the predetermined intervals corresponding to a transmission rate of each channel, and the priority ranking determination portion transmits, based on a data length of each channel and the value of the transmission demand counter, the highest priority channel designation signal which designates a variable length data transmission of a highest priority channel, and a signal which designates a subtraction of only a numerical value corresponding to a length of transmitted variable length data from the transmission demand counter corresponding to the highest priority channel.

7. The traffic control apparatus as claimed in claim 1 wherein the priority ranking determination portion performs weighting to the value of the transmission demand counter to determine the transmission priority ranking of each channel.

8. The traffic control apparatus as claimed in claim 1 wherein intervals of the transmission demand signals for each channel are set so that a total of transmission rates corresponding to the predetermined intervals set for each channel does not exceed a maximum transmission rate which can be transmitted by at least one of a transmission line and a virtual path including the channel.
